(19) United States
(12) Patent Application Publication
(10) Pub. No.: US 2024/0145736 A1
(43) Pub. Date: May 2, 2024

(54) ELECTRODE MODULE FOR A REDOX FLOW CELL, METHOD FOR ASSEMBLING SAME, AND REDOX FLOW CELL

(71) Applicant: Schaeffler Technologies AG & Co. KG, Herzogenaurach (DE)

(72) Inventors: Matthias Frank, München (DE); Yuan Yao, Herzogenaurach (DE)

(73) Assignee: Schaeffler Technologies AG & Co. KG, Herzogenaurach (DE)

(21) Appl. No.: 18/279,439

(22) PCT Filed: Jan. 18, 2022
(86) PCT No.: PCT/DE2022/100045

§ 371 Date: Aug. 30, 2023

(30) Foreign Application Priority Data
Mar. 9, 2021 (DE) 10 2021 105 597.0

(51) Int. Cl. H01M 8/0273; H01M 8/18

(52) U.S. Cl. CPC H01M 8/0273; H01M 8/188

(57) ABSTRACT

An electrode module for a redox flow cell comprises a frame having a peripheral seal which is arranged on an inner periphery of the frame and which has at least two inwardly directed elastic sealing lips. A peripheral groove is formed between two of the sealing lips. The electrode module also comprises an electrode having an outer periphery with which the electrode is seated in the groove of the seal.

### CROSS-REFERENCE TO RELATED APPLICATIONS

This application is the U.S. National Phase of PCT Appln. No. PCT/DE2022/100045 filed Jan. 18, 2022, which claims priority to DE 102021105597.0 filed Mar. 9, 2021, the entire disclosures of which are incorporated by reference herein.

### TECHNICAL FIELD

The present disclosure relates to an electrode module for a redox flow cell. The electrode module comprises a frame in which an electrode is arranged. The disclosure further relates to a redox flow cell and a method for assembling an electrode module for the redox flow cell, wherein the assembly simultaneously leads to a sealing of an electrode in the electrode module.

### BACKGROUND

From the prior art are known electric cells which are referred to as redox flow cells and with which redox flow batteries can be formed. In the designation “Redox”, “Red” stands for reduction in which an electron uptake can be seen. “Ox” stands for oxidation, in which an electron release is seen. Redox flow cells store electrical energy in chemical compounds in which the reaction partners are dissolved in a solvent. Two energy-storing electrolytes circulate within two separate circuits, between which an ion exchange takes place in the cell via a membrane. The energy-storing electrolytes can be stored outside the cell in separate tanks.

Redox flow cells can have a frame which frames a metal electrode of the cell. The frame represents a carrier frame for the electrode and is also used for sealing. A peripheral seal is required between the frame and the electrode. Since the electrolyte to be sealed is chemically aggressive, the choice of material for the seal is limited. The usual small wall thicknesses of the frame and the electrode also limit the selection of a suitable system for the sealing. Sealing solutions are known from the prior art, in which classic molded part seals are used. These molded part seals are usually fixed by a groove in the frame. An undercut groove is required in the frame for a force-fit connection which, due to the peripheral closed groove, leads to increased production costs. Since the frame typically has a wall thickness of less than 3 mm, a form-fitting groove connection is hardly possible due to the filigree nature of the frame. In addition, solutions for sealing are known from the prior art, in which what are termed formed-in-place seals (FIP) are used, which are applied by dispensing methods, which often prove to be economically unprofitable due to relatively long cycle times. In addition, the geometry of the sealing profile can only be influenced to a limited extent. Sealing systems with molded-part and FIP seals require an additional element to generate the seal preload. In addition, sealing compounds with elastic adhesives are used. Due to the chemical aggressiveness of the electrolyte, the adhesive can be washed out. In addition, greatly differing thermal expansions of the frame, which is formed from a thermoplastic material, and the metallic electrode lead to severe shearing stresses in the adhesive bead, particularly in the case of large formats. Both effects significantly reduce the service life of such a sealing system.

EP 2 693 087 A1 shows a sealing material for a thin plate element such as in a cell of a redox flow battery. The annular sealing material comprises a side sealing body disposed on one side of the thin plate member. The front and the rear of the thin plate element are arranged on two sealing legs branching off from the lateral sealing body.

WO 2014/198364 A1 shows an electrode module for a redox flow battery. The electrode module comprises an electrode and a sealing frame. The electrode should be connected to the sealing frame in such a way that the resulting electrode module can be used in redox flow cells without any problems. For this purpose, the electrode is mechanically connected to the sealing frame. A multi-lip seal may be arranged on the sealing frame and rests against a membrane. The sealing frame may have a peripheral groove which is designed to taper conically towards the outside. The channel may have an undercut.

WO 2013/016919 A1 shows a flow battery stack having a flow frame and having a collector plate arranged inside the flow frame. An ion exchange membrane is sandwiched between collector plates and forms a cavity in which an electrolyte is housed with the collector plate. An electrode is positioned within the cavity. Two sets of flow openings are formed on the sides of the flow frame.

A sealing frame for use in a battery is shown in EP 2 432 043 A1, which has a base body surrounding an opening. A trigger region is formed at an edge of the opening. A continuous drainage opening is formed in the base body adjacent to the trigger region. A cell with a cell housing is surrounded by a sealing seam. The cell is placed on the sealing frame in such a way that the cell housing extends into the opening in such a way that the sealed seam is in contact with the seal and that the sealed seam is not acted upon by the seal in the trigger region. At least one peripheral elastically compressible seal is provided, which encompasses the opening.

EP 3 113 272 A1 shows a frame body for a cell of a redox flow battery. The frame body comprises an opening formed within the frame body and a manifold through which an electrolyte can pass. A slit connecting the manifold and the opening has a pair of side walls facing each other in a cross-section orthogonal to a direction in which the electrolyte flows.

### SUMMARY

The present disclosure is to be able to fix an electrode for a redox flow cell within a frame in a simple and tight manner. Furthermore, thermal expansion should not lead to mechanical stresses that could impair the service life of the electrode.

The electrode module according to an exemplary embodiment of the present disclosure is intended for a redox flow cell. The redox flow cell is a wet cell and therefore an electrical accumulator. The redox flow cell stores electrical energy in chemical compounds, wherein the reaction partners are dissolved in a solvent in two energy-storing electrolytes. The two energy-storing electrolytes circulate in two separate circuits, between which an ion exchange takes place through a membrane in the cell. The redox flow cell can be formed by an organic flow cell made from non-toxic components. The redox flow cell is delimited by two electrodes. The electrodes are designed in the form of modules. Such a module is formed by the electrode module according to the present disclosure.

The electrode module comprises a frame that forms a support frame and also a sealing frame. For this purpose, the frame comprises a seal which is arranged on an inner periphery of the frame. The seal is formed peripherally on this inner periphery of the frame. The seal has at least two inwardly directed elastic sealing lips. The sealing lips are directed towards the inside of the frame, i.e., to a center point of the frame, which is in a space enclosed by the frame. A peripheral groove is formed between two of the sealing lips. The peripheral groove can be formed between two adjacent sealing lips. The opening of the groove is oriented towards the inside of the frame, i.e., to the center of the frame. The groove runs completely around the inner periphery of the frame. The seal is resistant to the chemically aggressive electrolytes in the redox flow cell.

The electrode module also comprises a metallic electrode. The electrode has an outer periphery with which the electrode is seated in the groove of the seal. The electrode protrudes into the groove of the seal so that it is seated between the two sealing lips and is clamped by them. This holds, fixes, and seals the electrode. The electrode protrudes into the groove along the peripheral direction thereof over the entire length of the groove. As the electrode is seated in the groove, it lies in the same plane as the frame and the seal. This level represents a main extension plane of the frame, the seal and the electrode. The seal encloses the electrode. The frame encloses the seal with the electrode seated therein.

A particular advantage of the electrode module is that the seal allows both the sealing of the electrode and the storage thereof. The electrode can be mounted quickly and easily in the frame, wherein a pre-tensioning force is already generated by the seal itself. The electrode can also be removed from the frame if required.

In embodiments, one of the two sealing lips is pressed onto an upper side of the electrode, while the other of the two sealing lips is pressed onto an underside of the electrode. The electrode is thus force-fitted between the two sealing lips. This leads to the advantage that the electrode is fixed in a direction perpendicular to the main extension plane thereof and is also securely sealed.

In embodiments, the outer perimeter of the electrode has peripheral clearance to a floor of the groove. The floor of the groove, like the groove, is designed to be peripheral. A line perpendicular to the floor can be in the main extension plane of the frame. This perpendicular line can point to a center point of the frame. The floor envelops the outer periphery of the electrode with a clearance, wherein a spacing, namely said clearance, is given to the outer periphery of the electrode. The clearance leads to the electrode being able to expand and move somewhat in the main extension plane thereof. The frame, which can be made of a thermoplastic material, and the metal electrode have different coefficients of thermal expansion. The clearance prevents to a greater extent the different thermal expansion coefficients leading to mechanical stresses when the temperature changes. Due to the clearance, the electrode is supported in a floating manner within the frame. The clearance can be at least as large as a thickness of the electrode. The clearance can be at least five times the thickness of the electrode.

In embodiments, one of the two sealing lips is designed as a snap-in lug, via which the electrode can be snapped into the groove. The sealing lip designed as the snap-in lug has an inner side surface delimiting the groove and an outer side surface opposite the inner side surface. The outer side surface is inclined relative to the main extension plane of the frame, so that when the electrode is inserted from outside the frame into the seal of the frame, the electrode can slide into the peripheral outer side surface of the sealing lip designed as the snap-in lug and in this case, this sealing lip folds over in the direction of the groove in a hinge-like manner until the electrode enters the groove via this sealing lip, whereupon this sealing lip snaps back like a hinge and comes to rest on the upper side of the electrode. In an undeformed state, the outer side surface has an angle relative to the main extension plane of the frame which can be greater than 45°. The design of one of the two sealing lips as the snap-in lug has the advantage that the electrode can be inserted into the frame very quickly and with little effort.

The sealing lip designed as the snap-in lug is also referred to below as a first sealing lip, while the other of the two sealing lips is referred to as a second sealing lip. The second sealing lip has an inner side surface delimiting the groove and an outer side surface opposite the inner side surface. The outer side surface of the second sealing lip can be inclined with respect to the main extension plane of the frame, but can be less than the outer side surface of the first sealing lip. In an undeformed state, the outer side surface of the second sealing lip has an angle relative to the main extension plane of the frame which can be between 10° and 45°. The second sealing lip can protrude further into the interior of the frame than the first sealing lip. Thus, the second sealing lip is in contact with the electrode in a region which is closer to the center point of the frame than a region in which the first sealing lip is in contact with the electrode. The second sealing lip thus has an extent in the main extension plane of the frame which can be at least 1.5 times greater than an extent which the first sealing lip has in the main extension plane of the frame. In this sense, the second sealing lip can be at least 1.5 times as high as the first sealing lip.

The inclination of the outer side surface of the first sealing lip and the inclination of the outer side surface of the second sealing lip also lead to a self-sealing effect. A pressure acting on the electrode also acts on the outer side surface of the respective sealing lip, so that the region of this sealing lip that touches the electrode is pressed more strongly against the electrode.

In embodiments, the seal is attached to the inner periphery of the frame in a form-fitting and/or material-fitting manner. This attachment ensures that the electrode seated in the seal is securely fixed and sealed against the frame.

In embodiments, the seal is affixed as an injection molded part to the inner periphery of the frame. As a result, the seal is fastened to the inner periphery of the frame in a form-fitting and material-fitting manner.

On the inner periphery thereof, the frame can have a stop that laterally delimits the inner periphery. The stop can be formed around the inner periphery. The stop forms a support for the seal.

A peripheral concave edge can be formed between the inner periphery and the stop. The inner periphery can be designed in such a way that a perpendicular lies on the periphery in the main extension plane of the frame. The stop can be aligned to be perpendicular to the inner periphery of the frame, so that the peripheral concave edge has an angle of 90°. The seal can be seated in the peripheral concave edge. The peripheral concave edge ensures that the seal is securely and tightly fixed in the frame.

In embodiments, the seal is incorporated as an injection molded part into the peripheral concave edge of the frame, as a result of which it is firmly and tightly connected to the frame there.

The seal can be elastic and can be a polymer. The polymer can be formed by a thermoplastic elastomer (TPE), by an ethylene-propylene-diene rubber (EPDM) or by a fluororubber (FKM). The seal or the polymer can be acid-resistant.

The frame can be a plastic. The frame can be made of a thermoplastic material. The frame can be acid resistant.

The metallic electrode can be a copper-zinc alloy or of a graphite. However, the electrode can also be another metal. The electrode can be designed to be porous. The electrode can be formed by a thin-walled structure. The electrode can be in the form of a rectangular plate. In this respect, the electrode has the shape of a flat cuboid.

The redox flow cell according to the present disclosure comprises two of the electrode modules according to the present disclosure. The two electrode modules can be arranged in alignment with one another. The two electrode modules can be of the same design. A membrane is arranged between the two electrode modules. Electrolytes can circulate between the electrodes. The two electrode modules can be designed according to one of the embodiments of the electrode module described above. In addition, the redox flow cell can also have features that have been indicated in connection with the electrode module according to the present disclosure.

The method according to the present disclosure serves to assemble an electrode module for a redox flow cell. In one step of the method, a metallic electrode for the redox flow cell is provided. In addition, a frame is provided into which the electrode is to be inserted. The frame has a seal disposed on an inner periphery of the frame and is formed peripherally. The seal has at least two inwardly directed elastic sealing lips, wherein a peripheral groove is formed between two of the sealing lips. In a further step, the electrode is pressed into the groove via one of the sealing lips. For this purpose, the electrode is arranged above the frame and a force is exerted on the electrode in a direction perpendicular to the main extension plane. As soon as the electrode is seated in the groove, the assembled electrode module is available. The electrode module can be the electrode module according to the present disclosure described above or in one of the embodiments of the electrode module according to the present disclosure described above. In this respect, the electrode to be provided for the method and the frame to be provided for the method can also have features that are described in connection with the electrode module according to the present disclosure.

When the electrode is pressed over the sealing lip, which can be designed as a snap-in lug, this sealing lip is folded over in the manner of a hinge, so that the electrode can slide over this sealing lip. This sealing lip then snaps back like a hinge so that the electrode is seated in the groove and is held in place by the prestressed sealing lips with a force fit. So that the electrode can slide over the sealing lip designed as a snap-in lug to get into the groove, the other of the two sealing lips can also yield in a hinge-like manner. As soon as the electrode is seated in the groove, this sealing lip also folds back and presses the electrode into the groove.

### BRIEF DESCRIPTION OF THE DRAWINGS

Additional advantages, details, and further developments of the present disclosure arise from the following description of an exemplary embodiment, with reference to the drawings. In the figures:

FIG. 1 shows an illustration of an exemplary embodiment of a method for assembling an electrode module according to the present disclosure;

FIG. 2 shows a first step of the method illustrated in FIG. 1;

FIG. 3 shows a second step of the method illustrated in FIG. 1;

FIG. 4 shows a third step of the method illustrated in FIG. 1; and

FIG. 5 shows the electrode module assembled according to the method illustrated in FIG. 1.

### DETAILED DESCRIPTION

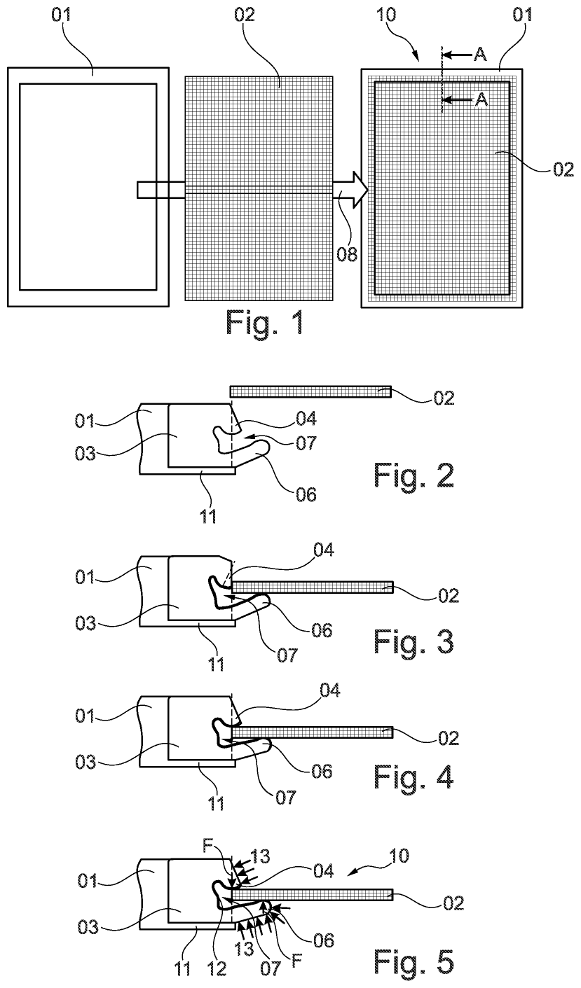

FIG. 1 shows an illustration of an exemplary embodiment of a method for assembling an electrode module according to the present disclosure. First, a rectangular frame 01 and a rectangular electrode 02 are provided. The frame 01 has an elastic seal 03 (shown in FIG. 2) formed all the way around on the inner periphery thereof. The seal 03 (shown in FIG. 2) comprises an inwardly directed first elastic sealing lip 04 and an inwardly directed second elastic sealing lip 06 (shown in FIG. 2), between which is formed a peripheral groove 07 (shown in FIG. 2).

An arrow 08 symbolizes the course of the method, in which the electrode 02 is pressed into the frame 01, so that the result is an electrode module 10 for a redox flow cell (not shown). The electrode module 10 represents an exemplary embodiment of an electrode module according to the present disclosure. The course of the method symbolized by the arrow 08 is shown in individual steps in FIGS. 2 to 4 for a section AA.

FIG. 2 shows a first step of the method illustrated in FIG. 1. In this step, the provided frame 01 and the provided electrode 02 are present. The electrode 02 is positioned in the middle above the frame 01. A cross-section of the inner peripheral seal 03 can be seen in the sectional view of the frame 01. The seal 03 is attached to the inner periphery of the frame 01, which is laterally delimited on one side by a stop 11, by injection molding in a materially bonded manner on the frame 01, and on the stop 11.

FIG. 3 shows a second step of the method illustrated in FIG. 1. The electrode 02 has already been partially pressed into the seal 01, so that the first sealing lip 04 has deformed in the direction of the groove 07.

FIG. 4 shows a third step of the method illustrated in FIG. 1. The electrode 02 has been pressed even further into the seal 01, so that the first sealing lip 04 has snapped over the electrode 02 like a snap-in lug, so that the electrode 02 is located in the groove 07 between the two sealing lips 04, 06.

FIG. 5 shows the electrode module 10 assembled according to the method illustrated in FIG. 1. The electrode 02 is located in the groove 07 of the seal 02, whereby the electrode 02 is fixed in the frame 01 and is sealed thereagainst. In the groove 07, the electrode 02 has some clearance relative to a floor 12 of the groove 07, so that the electrode 02 is supported in a floating manner in the seal 03.

Arrows 13 symbolize a system pressure which presses the sealing lips 04, 06 against the electrode 02 with a force F, whereby the sealing effect of the seal 03 is increased.

### LIST OF REFERENCE SYMBOLS

01 Frame
02 Electrode
03 Seal
04 First sealing lip
05 —
06 Second sealing lip
07 Groove
08 Arrow
09 —
10 Electrode module
11 Stop
12 Floor
13 Arrows

1. An electrode module for a redox flow cell, comprising:
a frame having a peripheral seal arranged on an inner periphery of the frame and having at least two inwardly directed elastic sealing lips, a peripheral groove being formed between two of the sealing lips; and
an electrode having an outer periphery with which the electrode is seated in the groove of the seal.

2. The electrode module according to claim 1, wherein one of the two sealing lips is pressed onto an upper side of the electrode and the other of the two sealing lips is pressed onto an underside of the electrode.

3. The electrode module according to claim 1, wherein the outer periphery of the electrode has peripheral clearance with respect to a floor of the groove.

4. The electrode module, according to claim 3, wherein the clearance is at least half as large as a thickness of the electrode.

5. The electrode module according, to claim 1, wherein one of the two sealing lips is designed as a snap-in lug, via which the electrode can be snapped into the groove.

6. The electrode module 1 according to claim 1, wherein the seal is fastened to the inner periphery of the frame in one of a form-fitting manner or a material-fitting manner.

7. The electrode module according to claim 1, wherein the seal is attached to the inner periphery of the frame as an injection molded part.

8. The electrode module according to claim 1, wherein the frame has a stop laterally delimiting the inner periphery on the inner periphery thereof, wherein between the inner periphery and the stop is formed a concave edge in which the seal is seated.

9. A redox flow cell, comprising:
a first electrode module, and second electrode module, and a membrane arranged therebetween;
each of the first electrode molecule and the second electrode module including:
a frame having a peripheral seal arranged on an inner periphery of the frame and having at least two inwardly directed elastic sealing lips, a peripheral groove being formed between two of the scaling lips; and
an electrode having an outer periphery with which the electrode is seated in the groove of the seal.

10. A method for assembling an electrode module for a redox flow cell, comprising:
providing an electrode;
providing a frame for the electrode, which has a seal arranged on an inner periphery of the frame and formed peripherally, wherein the seal has at least two inwardly directed elastic sealing lips, wherein a peripheral groove is formed between two of the sealing lips; and
pressing the electrode over one of the sealing lips into the groove.

11. The electrode module according to claim 2, wherein the other of the two sealing lips has an extent in a main extension plane of the frame that is greater than an extent of the one of the two sealing lips in the main extension plane of the frame.

12. The electrode module according to claim 1, wherein each sealing lip includes an inner surface delimiting the groove and an outer surface opposite the respective inner surface, the outer surface of one of the two sealing lips extending at a first angle relative to a main extension plane of the frame, and the outer surface of the other of the two sealing lips extending at a second angle relative to the main extension plane of the frame, wherein the first angle is greater than the second angle.

13. The electrode module according to claim 12, wherein the other of the two sealing lips extends further into an interior of the frame than the one of the two sealing lips extends into the interior of the frame.

14. The electrode module according to claim 12, wherein the other of the two sealing lips is in contact with the electrode in a region that is closer to a center of the frame than a region in which the one of the two sealing lips is in contact with the electrode.

15. The redox flow cell according to claim 9, wherein each sealing lip includes an inner surface delimiting the groove and an outer surface opposite the respective inner surface, the outer surface of one of the two sealing lips extending at a first angle relative to a main extension plane of the frame, and the outer surface of the other of the two sealing lips extending at a second angle relative to the main extension plane of the frame, wherein the first angle is greater than the second angle.

16. The redox flow cell according to claim 15, wherein the other of the two sealing lips extends further into an interior of the frame than the one of the two sealing lips extends into the interior of the frame.

17. The redox flow cell according to claim 15, wherein the other of the two sealing lips is in contact with the electrode in a region that is closer to a center of the frame than a region in which the one of the two sealing lips is in contact with the electrode.

18. The method according to claim 10, wherein each sealing lip includes an inner surface delimiting the groove and an outer surface opposite the respective inner surface, the outer surface of one of the two sealing lips extending at a first angle relative to a main extension plane of the frame, and the outer surface of the other of the two sealing lips extending at a second angle relative to the main extension plane of the frame, wherein the first angle is greater than the second angle.

19. The method according to claim 18, wherein the other of the two sealing lips extends further into an interior of the frame than the one of the two sealing lips extends into the interior of the frame.

20. The method according to claim 18, wherein the other of the two sealing lips is in contact with the electrode in a region that is closer to a center of the frame than a region in which the one of the two sealing lips is in contact with the electrode.
